(19) United States
(12) Patent Application Publication
(10) Pub. No.: US 2016/0252036 A1
(43) Pub. Date: Sep. 1, 2016

(54) SYSTEM AND METHOD FOR CONTROLLING AIR-FUEL RATIO

(71) Applicant: Caterpillar Inc., Peoria, IL (US)

(72) Inventors: Hua Xu, Dunlap, IL (US); Arvind Sivasubramanian, Peoria, IL (US); Shaun D. Fogle, Peoria, IL (US); David J. Lin, Peoria, IL (US)

(73) Assignee: Caterpillar Inc., Peoria, IL (US)

(21) Appl. No.: 15/150,751

(22) Filed: May 10, 2016

(51) Int. Cl. F02D 41/24; F02D 41/14

(52) U.S. Cl. CPC F02D 41/2461; F02D 41/1461

(57) ABSTRACT

The disclosure provides a method to operate an engine system. The method begins by determination of a current NOₓ value. If the current NOₓ value is greater than a first predetermined NOₓ target, an air-fuel ratio (AFR) set-point is adjusted by a first predetermined value in towards a rich AFR. Upon detection of the current NOₓ value below the first predetermined NOₓ target, a first average of NOₓ values for a first predetermined time is determined. The AFR set-point is adjusted by a second predetermined value and a second average of NOₓ values for a second predetermined time is determined. A delta NOₓ value is determined as a difference between the first average and the second average and compared with a second predetermined NOₓ target. The AFR set-point is determined when the delta NOₓ value is below the second predetermined NOₓ target.

### TECHNICAL FIELD

The present disclosure generally relates to a method of controlling an air-fuel ratio (AFR) in an engine system. More particularly, the present disclosure relates to the method to automatically control the AFR, for efficient conversion of emissions by a three-way catalyst positioned downstream of an exhaust manifold of the engine system.

### BACKGROUND

Engine systems commonly employ an engine and an exhaust aftertreatment system. During a combustion process, the engine typically bums a stoichiometric mixture of air and fuel corresponding to an air-fuel ratio (AFR), to produce required power. In the combustion process, the engine typically produces various emissions, which include oxides of nitrogen (NOₓ), ammonia (NH₃), Carbon monoxide (CO), and other non-methane hydrocarbons (NMHC). The emissions are then treated and reduced by the exhaust aftertreatment system. The exhaust aftertreatment system includes a three-way catalyst, which reduces these emissions into less polluting compounds. The three-way catalyst may be required to operate at a maximum conversion efficiency to maintain the emissions below permissible limits. To attain the maximum conversion efficiency, the three-way catalyst operates at the AFR, which is adjusted to be equal to a particular AFR set-point. However, with change in operating conditions of the engine, the AFR set-point may also change. Therefore, the AFR set-point is required to be adjusted to achieve maximum efficiency of the three-way catalyst.

Typically, an oxygen (O₂) sensor is positioned downstream of the three-way catalyst and is in communication with an engine control module (ECM). The O₂ sensor detects oxygen content in the exhaust gas and generates signals related to the oxygen content. The ECM modulates the AFR set-point based on the signals from the O₂ sensor. However, the O₂ sensor is incapable to determine NH₃ and NOₓ content in the exhaust gas. Moreover, the AFR set-point may vary with operational parameters of the engine, such as, but not limited to, engine speed, engine load, fuel quality, catalyst degradation, and/or engine temperature. Therefore, an operator may be required to manually adjust the AFR set-point with the help of an emission analyzer to determine the optimal AFR set-point. However, it may be cumbersome for the operator to manually determine and repeatedly adjust the AFR set-point.

U.S. Pat. No. 9,206,755 (the '755 patent) describes a method to control the AFR set-point. The '755 patent determines the AFR set-point when the minimum NOₓ sensor output is reached. The method uses the combined properties of the combustion, catalyst, and NOₓ sensor to automatically determine the AFR set-point. However, the determined AFR may be potentially rich in the duration while the AFR set-point is determined. This may result in more NH₃, CO, and NMHC in the exhaust gas, which is undesirable.

Hence, there is a need for an improved system to automatically adjust the AFR set-point.

### SUMMARY OF THE DISCLOSURE

The disclosure provides a method to operate an engine system. The engine system includes a nitrogen oxide (NOₓ) sensor positioned downstream of a three-way catalyst with respect to an exhaust gas flow. The NOₓ sensor determines a current NOₓ value of the exhaust gas. The current NOₓ value is compared with a first predetermined NOₓ target. When the current NOₓ value is greater than the first predetermined NOₓ target, an air-fuel ratio (AFR) set-point is selectively adjusted towards a rich AFR by a first predetermined value. The first predetermined value varies on the basis of a difference between the current NOₓ value and the first predetermined NOₓ target. Upon detection of the current NOₓ value below the first predetermined NOₓ target, a first average of NOₓ values is determined for a first predetermined time. Thereafter, the AFR set-point is adjusted by a second predetermined value. A second average of NOₓ values is determined for a second predetermined time. A delta NOₓ value is determined, wherein the delta NOₓ value comprises a difference between the first average and the second average. The delta NOₓ value is compared with a second predetermined NOₓ target. The AFR set-point is repeatedly adjusted by the second predetermined value, until the delta NOₓ value is below the second predetermined NOₓ target.

### BRIEF DESCRIPTION OF THE DRAWINGS

FIG. 1 is a schematic of an exemplary engine system, in accordance with the concepts of the present disclosure; and

FIG. 2 is a flow chart of a method to control an air-fuel ratio (AFR) in the engine system of FIG. 1, in accordance with the concepts of the present disclosure.

### DETAILED DESCRIPTION

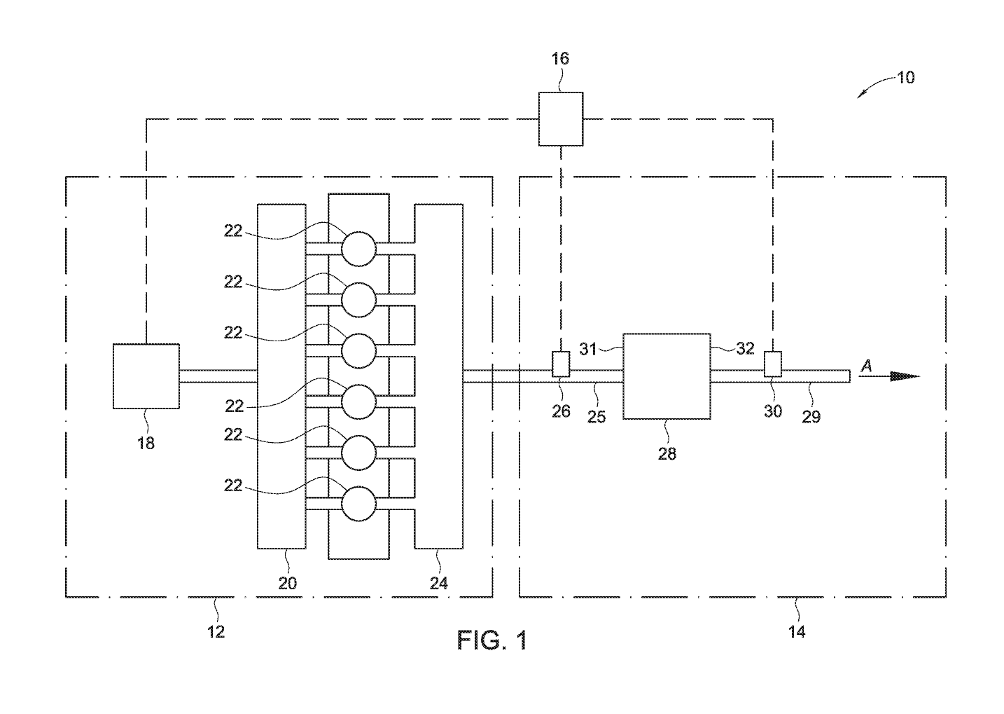

Referring to FIG. 1, there is shown an engine system 10 that includes an engine 12, an exhaust aftertreatment system 14, and an engine control module (ECM) 16. The engine 12 includes an air-fuel regulator 18, an intake manifold 20, a multiplicity of cylinders 22, and an exhaust manifold 24. Although the present disclosure describes the engine 12 as a natural gas fuel engine, various other types of the engines such as a compression-ignition diesel engine, a spark-ignited gasoline engine, or a dual engine may also be contemplated.

The air-fuel regulator 18 is positioned upstream of the intake manifold 20. The air-fuel regulator 18 is controlled by the ECM 16. The ECM 16 communicates an air-fuel ratio (AFR) value depending upon an existing operating condition. The air-fuel regulator 18 controls a flow of air and fuel to the intake manifold 20. Examples of the air-fuel regulator 18 may embody, such as but not limited to, a throttle, a control valve, or an injector.

The intake manifold 20 is positioned downstream of the air-fuel regulator 18 of the engine 12. The intake manifold 20 is fluidly connected to the cylinders 22 and disposed upstream of the cylinders 22. The intake manifold 20 supplies an air-fuel mixture to the cylinders 22 for combustion.

The cylinders 22 are disposed upstream to the exhaust manifold 24. The cylinders 22 are equipped with an ignition mechanism which combusts the received air-fuel mixture, to produce power. During combustion of the air-fuel mixture, exhaust gas is produced and is ejected to the exhaust manifold 24.

The exhaust manifold 24 is fluidly connected to the cylinders 22 and the exhaust aftertreatment system 14. The exhaust manifold 24 is disposed upstream of the exhaust aftertreatment system 14. The exhaust manifold 24 navigates the received exhaust gas from the cylinders 22 to the exhaust aftertreatment system 14.

The exhaust aftertreatment system 14 is positioned downstream of the exhaust manifold 24 to receive the exhaust gas produced by the engine 12. The exhaust aftertreatment system 14 includes a first exhaust conduit 25, an oxygen (O₂) sensor 26, a three-way catalyst 28, a second exhaust conduit 29, and a nitrogen oxide (NOₓ) sensor 30. Although the present disclosure describes the exhaust aftertreatment system 14 employed with the three-way catalyst 28, the exhaust aftertreatment system 14 may also employ various other components to filter and convert various compounds of the exhaust gas into non-polluting compounds.

The first exhaust conduit 25 is disposed downstream and fluidly connected to the exhaust manifold 24, at one end, with respect to a flow, A of the exhaust gas. Another end of the first exhaust conduit 25 is disposed downstream and fluidly connected to the three-way catalyst 28. In other words, the first exhaust conduit 25 connects the exhaust manifold 24 and the three-way catalyst 28, to provide fluid communication therebetween. The first exhaust conduit 25 accommodates the O₂ sensor 26.

The O₂ sensor 26 is positioned downstream of the exhaust manifold 24 and upstream of the three-way catalyst 28, with respect to the flow A, of the exhaust gas. The O₂ sensor 26 may typically be screwed into a threaded hole in the first exhaust conduit 25. The O₂ sensor 26 is a ceramic cylinder, which is plated inside and out with porous platinum electrodes. The O₂ sensor 26 is operable to measure oxygen content in the exhaust gas that exits from the exhaust manifold 24 and generate an O₂ detection signal for the same. The O₂ sensor 26 further sends the O₂ detection signal to the ECM 16.

The three-way catalyst 28 is positioned downstream of the O₂ sensor 26, and upstream of the second exhaust conduit 29, with respect to the flow A, of the exhaust gas. The three-way catalyst 28 is a non-selective catalyst and reduces NOₓ and oxidizes ammonia (NH₃), carbon monoxide (CO), and non-methane hydrocarbons (NMHC). The three-way catalyst 28 includes a first end 31 and second end 32. The first end 31 is in fluid communication with the first exhaust conduit 25. The first end receives the exhaust gas from first exhaust conduit 25 for treatment. The treated exhaust gas exits the three-way catalyst 28 via the second end 32. The second end 32 is fluidly connected to the second exhaust conduit 29. The three-way catalyst 28 is most efficient, at a certain AFR, referred to as an optimal AFR set-point.

The second exhaust conduit 29 is disposed downstream and fluidly connected to the three-way catalyst 28, at one end, with respect to the flow A, of the exhaust gas. Another end of the second exhaust conduit 29 ejects the exhaust gas to an ambient environment. In other words, the second exhaust conduit 29 navigates the treated exhaust gas out of the exhaust aftertreatment system 14. In addition, the second exhaust conduit 29 accommodates the NOₓ sensor 30.

The NOₓ sensor 30 is mounted in the second exhaust conduit 29 and positioned downstream of the three-way catalyst 28, with respect to the flow A of the exhaust gas. The NOₓ sensor 30 may be constructed from ceramic-type metal oxides, such as yttria-stabilized zirconia (YSZ). The NOₓ sensor 30 is operable to measure a current NOₓ value in the treated exhaust gas, in real time. The NOₓ sensor 30 detects the current NOₓ value and generates a NOₓ detection signal, which is further communicated to the ECM 16

The ECM 16 is a processing and controlling unit. The ECM 16 is in communication with the O₂ sensor 26, the NOₓ sensor 30, and the air-fuel regulator 18. The ECM 16 is adapted to receive the NOₓ detection signal from the NOₓ sensor 30, corresponding to the current NOₓ value. The ECM 16 is connected to the air-fuel regulator 18. The ECM 16 sends a signal to the air-fuel regulator 18 to adjust the AFR.

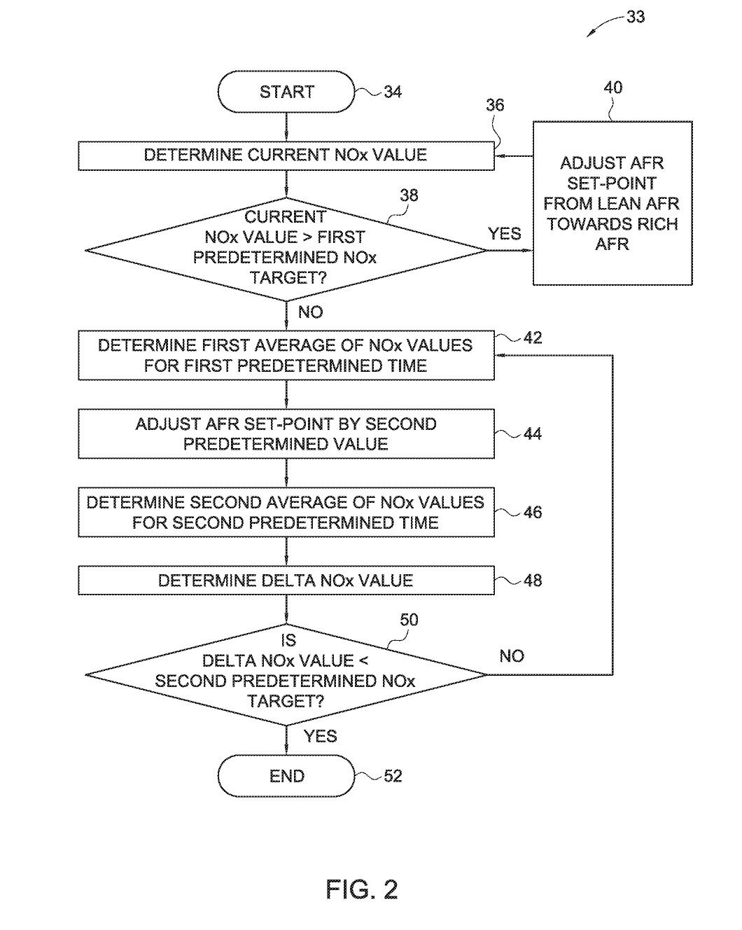

The ECM 16 controls a method 33 to determine the AFR set-point for the air-fuel regulator 18, as shown in a flowchart in FIG. 2. The ECM 16 determines the current NOₓ value via the NOₓ detection signal of the NOₓ sensor 30. The ECM 16 compares the current NOₓ value with the first predetermined NOₓ target. The ECM 16 modulates the AFR set-point for the air-fuel regulator 18 by a first predetermined value till the current NOₓ value is greater than the first predetermined NOₓ target. It may be contemplated that the first predetermined value is a variable value dependent on a difference between the current NOₓ value and the first predetermined NOₓ target. When the current NOₓ value approaches the first predetermined NOₓ target, the first predetermined value gets smaller and smaller. In another words, the AFR adjustment gets smaller and smaller when the current NOₓ value approaches the first predetermined NOₓ target, and continues until the current NOₓ value is equal to or smaller than the first predetermined NOₓ target.

The first predetermined value is based on a difference between the current NOₓ value and the first predetermined NOₓ target.

Upon determination that the current NOₓ value is lesser than the first predetermined NOₓ target, the ECM 16 operates to selectively control the AFR set-point. The ECM 16 determines a first average of NOₓ values of the exhaust gas over a first predetermined time. The ECM 16 adjusts the AFR set-point by a second predetermined value. The second predetermined value is relatively smaller than the first predetermined value. Thereafter, the ECM 16 determines a second average of NOₓ values of the exhaust gas over a second predetermined time. The ECM 16 determines a delta NOₓ value, which is a difference between the first average and the second average. The ECM 16 compares the delta NOₓ value with a second predetermined NOₓ target. The ECM 16 continues to selectively control the AFR set-point till the delta NOₓ value is greater than the second predetermined NOₓ target.

The ECM 16 may be any controller in the engine system 10 to perform one or more control operations. Examples of the ECM may include, but is not limited to, an 8051 microcontroller, a microprocessor, an 8085 microcontroller, and the like.

### INDUSTRIAL APPLICABILITY

In operation, the ECM 16 operates at a particular AFR set-point and likewise, signals the air-fuel regulator 18 to adjust the air-fuel mixture to be delivered to the intake manifold 20. The intake manifold 20 receives the air-fuel mixture at the AFR set-point and delivers the same to the cylinders 22, where the air-fuel mixture is combusted to generate power. The exhaust gas thus produced in the combustion flows to the exhaust manifold 24, and thereafter to the exhaust aftertreatment system 14. Downstream of the exhaust manifold 24, the ECM 16 continuously monitors the exhaust gas for emissions to control the AFR set-point for the engine 12, by use of the method 33. Referring to FIG. 2, there is shown the flowchart for the method 33 to automatically control the AFR of the engine 12. The method 33 initiates at step 34 and then, proceeds to step 36.

At step 36, the ECM 16 receives the NOₓ detection signal corresponding to an amount of NOx concentration in the exhaust gas exiting the three-way catalyst 28, via the NOₓ sensor 30. The ECM 16 determines the current NOₓ value based on the received NOₓ detection signal. The method 33 proceeds to step 38.

At step 38, the ECM 16 compares the current NOₓ value with the first predetermined NOₓ target. Thereafter, the ECM 16 determines whether the current NOₓ value is more than the first predetermined NOₓ target. For ease in reference and understanding, the first predetermined NOₓ target will be hereinafter referred to as a NOₓ coarse target. In the present embodiment, the NOₓ coarse target is 200 ppm (parts per million). If the current NOₓ value is greater than 200 ppm, the method 33 proceeds to step 40. If the current NOₓ value is equal to or lesser than 200 ppm, the method 33 proceeds to step 42.

At step 40, the ECM 16 selectively adjusts the AFR set-point from the lean AFR towards the rich AFR of the air-fuel mixture, by the first predetermined value. The first predetermined value is a variable value dependent on the difference between the current NOₓ value and the first predetermined NOₓ target. The first predetermined value varies with the difference between the current NOₓ value and the NOₓ coarse target. When the current NOₓ value approaches the first predetermined NOₓ target, the first predetermined value gets smaller and smaller. In another words, the AFR adjustment gets smaller and smaller when the current NOₓ value approaches the first predetermined NOₓ target. The ECM 16 sends signals to the air-fuel regulator 18 to change the AFR that corresponds to the shifted AFR set-point. This change in the air-fuel mixture by the air-fuel regulator 18 may be spread over multiple step adjustments, in order to result in an overall shift of the AFR set-point that corresponds to the first predetermined value. The method 33 returns to step 36.

The steps 42-50 discuss the steps of method 33 in which the ECM 16 selectively controls the AFR set-point by the second predetermined value if the current NOₓ value is lesser than the first predetermined NOₓ target, such that the second predetermined value is relatively smaller than the first predetermined value.

At step 42, the ECM 16 waits for a predetermined time lag. Upon completion of the predetermined time lag, the ECM 16 records the NOₓ values based on the NOₓ detection signals received from the NOₓ sensor 30, for a duration of the first predetermined time. Upon completion of the first predetermined time, the ECM 16 determines the first average of the NOₓ values that are recorded over the first predetermined time. The method 33 proceeds to step 44.

At step 44, the ECM 16 adjusts the AFR set-point by the second predetermined value. The second predetermined value is relatively smaller than the first predetermined value. The ECM 16 sends the signal to the air-fuel regulator 18 to change the AFR, which corresponds to the AFR set-point. The method 33 proceeds to step 46.

At step 46, the ECM 16 records the NOₓ values based on the NOₓ detection signals received from the NOₓ sensor 30, over the second predetermined time. This is done after a predetermined time lag upon completion of the step 44. The ECM 16 determines the second average of all the NOₓ values in the second predetermined time. The method 33 proceeds to step 48.

At step 48, the ECM 16 determines the delta NOₓ value. The delta NOₓ value is calculated by determination of the difference between the first average and the second average of the NOₓ values. The method 33 proceeds to step 50.

At step 50, the ECM 16 compares the delta NOₓ value with the second predetermined NOₓ target. Thereafter, the ECM 16 determines whether the delta NOₓ value is less than the second predetermined NOₓ target. For ease in reference and understanding, the second predetermined NOₓ target will hereinafter he referred to as a delta NOₓ target. In the present embodiment, the delta NOₓ target is 10 ppm. If the delta NOₓ value is equal to or lesser than 10 ppm, then the method 33 proceeds to end step 52. If the delta NOₓ value is greater than 10 ppm, then the method 33 returns to step 42. Further, the AFR set-point is repeatedly controlled through steps 42-50, if the delta NOₓ value is greater than the second predetermined NOₓ target.

At end step 52, the ECM 16 determines the current AFR set-point that corresponds to the current NOₓ value as an optimum AFR set-point for a current operating condition of the engine 12.

As the aforementioned method 33 follows a relatively shorter and simpler algorithm and works in the lean zone of air-fuel mixture, the method 33 is relatively more efficient. Further, as the NOₓ sensor 30 is sensitive to the NOₓ and NH₃, traces of CO or NH₃ in the exhaust gas are also minimized. Moreover, the AFR set-point adjustment is based on data of a number of NOₓ values recorded and averaged out over a period of time for different working conditions. This makes this method 33 of AFR adjustment more reliable and efficiently flexible when the operating conditions change.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A method of controlling an air-fuel ratio (AFR) in an engine system, the engine system including a nitrogen oxide (NOₓ) sensor positioned downstream of a three-way catalyst with respect to a flow of an exhaust gas, the method comprising:
receiving a current NOₓ value of the exhaust gas from the NOₓ sensor;
comparing the current NOₓ value with a first predetermined NOₓ target;
selectively adjusting an AFR set-point from a lean AFR towards a rich AFR if the current NOₓ value is greater than the first predetermined NOₓ target, such that the AFR set-point is adjusted by a first predetermined value, wherein the first predetermined value varies according to a difference between the current NOₓ value and the first predetermined NOₓ target; and
selectively controlling the AFR set-point by a second predetermined value if the current NOₓ value is lesser than the first predetermined NOₓ target, such that the second predetermined value is relatively smaller than the first predetermined value, wherein controlling the AFR set-point further includes:
determining a first average of NOₓ values of the exhaust gas over a first predetermined time;
adjusting the AFR set-point by the second predetermined value;
determining a second average of NO values of the exhaust gas over a second predetermined time;
determining a delta NOₓ value, wherein the delta NOₓ value is a difference between the first average and the second average; and
comparing the delta NOₓ value with a second predetermined NOₓ target,
wherein the AFR set-point is repeatedly controlled if the delta NOₓ value is greater than the second predetermined NOₓ target.
